(19) United States
(12) Patent Application Publication
(10) Pub. No.: US 2014/0025670 A1
(43) Pub. Date: Jan. 23, 2014

(54) LOCATION BASED RECOMMENDATIONS

(71) Applicant: BERRIN, LLC, Los Angeles, CA (US)

(72) Inventors: Berrin Daran, Los Angeles, CA (US); Luke Stephan Ireland, Oxford (GB); James Timothy Gathercole, Essex (GB)

(73) Assignee: BERRIN, LLC, Los Angeles, CA (US)

(21) Appl. No.: 13/946,539

(22) Filed: Jul. 19, 2013

Related U.S. Application Data
(60) Provisional application No. 61/673,311, filed on Jul. 19, 2012.

(51) Int. Cl. G06F 17/30

(52) U.S. Cl. CPC G06F 17/3053; G06F 17/30241
USPC 707/724

(57) ABSTRACT

A method disclosed herein comprises ranking a service provider or a product for a user based on scorings of the service provider by one or more members of a network of the user and weights assigned to each of the scorings, wherein the weights are determined based on the user.

### CROSS-REFERENCE TO RELATED APPLICATIONS

The present application claims benefit of priority to U.S. Provisional Patent Application No. 61/673,311 entitled “Location Based Recommendations” and filed on 19 Jul. 2012, which is specifically incorporated by reference herein for all that it discloses or teaches.

### FIELD

Implementations disclosed herein relate, in general, to the information management technology and specifically to technology for generating recommendations.

### SUMMARY

A method disclosed herein comprises ranking a service provider for a user based on scorings of the service provider by one or more members of a network of the user and weights assigned to each of the scorings, wherein the weights are determined based on the user.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Other features, details, utilities, and advantages of the claimed subject matter will be apparent from the following more particular written Detailed Description of various embodiments and implementations as further illustrated in the accompanying drawings and defined in the appended claims.

### BRIEF DESCRIPTION OF THE DRAWINGS

A further understanding of the nature and advantages of the present technology may be realized by reference to the figures, which are described in the remaining portion of the specification. In the figures, like reference numerals are used throughout several figures to refer to similar components. In some instances, a reference numeral may have an associated sub-label consisting of a lower-case letter to denote one of multiple similar components. When reference is made to a reference numeral without specification of a sub-label, the reference is intended to refer to all such multiple similar components.

FIG. 1 illustrates an example block diagram representing functioning of a recommendation system disclosed herein.

FIG. 2 illustrates an alternative example block diagram representing functioning of a recommendation system disclosed herein.

FIG. 3 illustrates an example flowchart of various operations performed by the recommendation system disclosed herein.

FIG. 4 illustrates an example user interface that may be used by the recommendation system to collect information from a user.

FIG. 5 illustrates an example user interface for receiving location information from a user.

FIG. 6 illustrates an example user interface for receiving area of interest information from a user.

FIG. 7 illustrates an example list of services that can be selected by a user.

FIG. 8 illustrates an example user interface for providing recommendations to a user.

FIG. 9 illustrates another example user interface for providing recommendations to a user.

FIG. 10 illustrates an example rating score generator table.

FIG. 11 illustrates an example diagram illustrating generating weights for users' rankings.

FIG. 12 illustrates an example flowchart for generating location based recommendations.

FIG. 13 illustrates an example flowchart for providing detailed review information to users.

FIG. 14 illustrates an example flowchart for providing community functions for various users in the location based recommendation system.

FIG. 15 illustrates an example computing system that can be used to implement the recommendation system disclosed herein.

FIG. 16 illustrates an example mobile computing device that can be used to implement one or more components of the recommendation system disclosed herein.

### DETAILED DESCRIPTION

In modern economies people are highly mobile. For example, millions of people travel around their country or around the world to visit new places, cities, friends, families, etc. Furthermore, in countries like the United States and several European countries, people also move quite a few times during their lifetime for new jobs, family reasons, etc. Each time someone moves to a different destination or travels to a different destination he/she needs information about the destination location. For example, if Mary is traveling from New York to Los Angeles for a week long vacation, Mary may need information about the local grocery stores, coffee houses, restaurants, health clubs, medical service providers, etc.

To help us with finding different items or services and the reviews of such items or services, Mary may be able to use apps like Yelp™, Yell™, AngiesList™, etc. However, these apps only offer suggestions for only one thing at a time. Thus, if Mary is looking for reviews of restaurants in the area of her lodging in Los Angeles, Mary will have to first get a list of all the restaurants within a given distance and then look up reviews for each of the restaurants on the list individually. Furthermore, the existing websites and apps build their reviews and suggestions based on the opinions of strangers. For example, the Yelp™ provides recommendations for restaurants based on the comments and reviews by the users of the restaurants. In this case, Mary would have almost no information about the people who are providing the reviews or rankings for the restaurants. As a result, Mary may not be able to rely on such reviews. Specifically, there is no relation between the user providing the review of the restaurant and the users that are in Mary's social network. Also, there is no information about whether the person providing the advice is trusted by other people in general or not. In other words, there is no ratings or rankings for the reviewers.

A recommendation system disclosed herein allows generating and providing recommendations based on location selected by a user. Specifically, the recommendation system disclosed herein uses the interconnectedness of users with other friends, family members, etc., to generate recommendations based on people in the social network of the user, such as the Facebook™, Twitter™, etc. For example, when Mary is looking for restaurants in the Santa Monica area of Los Angeles, the recommendation system may use reviews provided by the members of Mary's social network in the Los Angeles area or in Southern California to generate such recommendations. An implementation of the system allows a user to select the social networks that the user would like to use in generating the reviews and recommendations. For example, Mary can select Facebook™ and Twitter™, but decide not use LinkedIn™ for the recommendation system.

In an alternative implementation of the recommendation system, reviews and recommendations from various users are provided a weighting. For example, the recommendation system provides higher weight to a user's recommendation if that user's recommendation is positively viewed in the past. For example, if the recommendation system determines that a user John is a food critic, the recommendation system may provide higher weight to the restaurant reviews provided by John. An implementation of the recommendation system collects information about the reviewers from the Internet, various social networks, etc. For example, the recommendation system may use a web crawler to find information about John to determine that John is a food critic. The recommendation system may also use one or more databases provided by various search engines, or an application programming interfaces (APIs) to such search engines to collect such information about reviewers.

An alternative implementation of the recommendation system also allows users to select the people that are trusted for providing such recommendations. For example, if Mary does not trust food recommendations from Paul, she can request the recommendation system to ignore the review and ratings provided by Paul. On the other hand, if Mary highly trusts restaurant recommendation from her friend Peter, she can request the recommendation system to use higher weighting for the recommendation provided by Peter.

Alternatively, the recommendation system also allows a user to select a range of distance around a given location for the reviews of the selected services. For example, once Mary has selected Santa Monica as the location for the list of restaurants, she can select to get reviews for restaurants within a one-mile radius of downtown Santa Monica. In one implementation, such range of distance may be selected using a mapping application interface to the recommendation system where Mary can simply select the range of distance using her fingers. Alternatively, Mary can select to get all the restaurants within a given zip code, borders of a given township, etc.

Once Mary selects the location and the range, she can subsequently select the type of services that she would like to have recommendations. In an alternative implementation, Mary may be able to select the type of services first and then select the location, ranges, etc. For example, Mary can select restaurants, cafes, health clubs, etc., from a list of services. Once the recommendation system has received these choices from Mary, the system generates recommendation based on the analysis of reviews, ratings, etc., from various users in Mary's social network as well as the weightings provided to each of these users.

In one example implementation, the weightings for the users are generated using sentiment analysis of various postings by the users. For example, if Tim, who is in Mary's social network has provided a review of a restaurant in very effusive terms using words such as “excellent service,” “great menu,” etc., a sentiment analysis module of the recommendation system generates a high rating for that restaurant from Tim. Note that such sentiment analysis module may be an API that is used by the recommendation system disclosed herein.

Yet alternatively, the recommendation system also generates the weighting based on how closely a reviewer is connected to the person requesting the recommendation. For example, if Bob is directly connected to Mary via a social network, reviews by Bob are provided higher weight. On the other hand, if Steve is connected to Mary through Bob, reviews generated by Steve are provided a slightly lower weight. In other words, the weighting provided to a users review is in part based on the degrees by which the user is separated from the person requesting the review.

An alternative implementation of the recommendation system disclosed herein allows users providing recommendations to earn badges, accolades, etc., for providing good reviews and recommendations. For example, if Rob provides recommendation for a restaurant that is approved by other users as accurate or useful, Rob may be provided badges, accolades, and/or a special status. In such a case, future reviews by Rob will be weighed with higher weight levels.

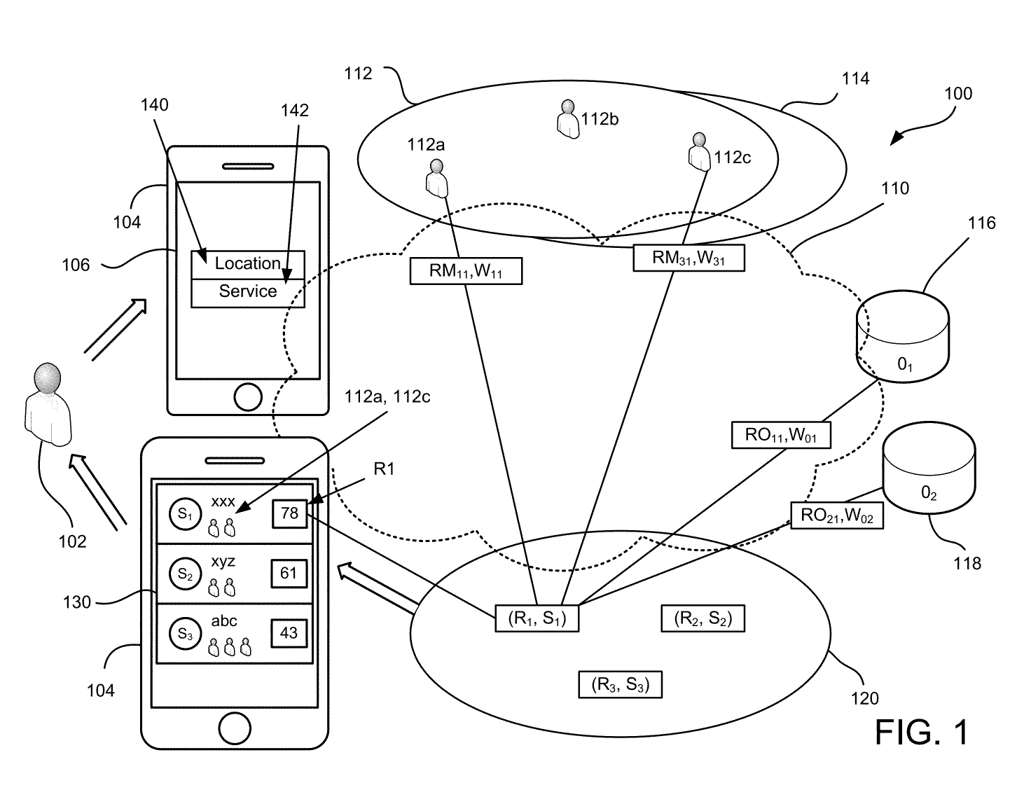

FIG. 1 illustrates an example block diagram representing functioning of a recommendation system 100 disclosed herein. The recommendation system 100 is configured to provide recommendations to a user 102 for various products and services for a selected geographic location. The user 102 may be an individual using a device 104, such as a cell phone, a smartphone, a personal data assistant (PDA), a tablet device, a laptop, a desktop, etc., to use the recommendation system 100. For example, the user may access a graphical user interface (GUI) provided on the device 104 to provide location information and the service or product (used hereinafter as “service”) information, etc. In one implementation, an app on the device 104 may be used to access the functionalities of the recommendation system 100.

Specifically, the user 102 may be an individual that is moving from Chicago to Denver and is interested in finding out more about various fitness centers in Denver. In such a case, the user 102 may select a location 140 as Denver and a service 142 as fitness centers. For example, the user may simply add the location 140 and the service 142 by typing it in or by using a drop-down menu, etc. In an alternative implementation, the location 140 may be selected based on the geographic location of the user 102. Thus, for example, if the user 102 is already in Denver, the location 140 may be determined to be Denver using GPS or other similar means.

The device 104 is connected to a communication network, such as the Internet 110 via PSTN, a mobile network, etc. In the implementation illustrated in FIG. 1, the device 104 is connected via the Internet 102 to various networks, such as a social network 112, a business network 114, etc. For example, the social network 112 may be Facebook™, Twitter™, Pinterest™, etc. Similarly, the business 114 may be LinkedIn™, etc. Specifically, the user 102 may be connected to a number of members of the networks 112, 114. In the example illustrated in FIG. 1, the user 102 is connected to members 112a, 112b, 112c, etc., in the social network 112.

Furthermore, the Internet 110 is also connected to other external organizations 116, 118, etc., that provide information that can be used by the recommendation system 100. For example, when generating recommendations, the recommendation system 100 may also contact service providers such as Yelp™, AngiesList™, etc., for review information, recommendation information, etc., for various services.

Once the user 102 has selected the location 140 and the service 142, the recommendation system 100 uses the location and service information to select and analyze information from the networks 112, 114, the organizations 116, 118, etc. For example, the recommendation system 100 selects information related to members 112a and 112c to generate a recommendation for a fitness center in Denver. Such selection may be based on a number of factors, such as interaction between the user 102 and the members 112a and 112c, the location of the members 112a and 112c, the participation in fitness related activities by the members 112a and 112c, the confidence shown by other members into the recommendations provided by the members 112a and 112c, etc. For example, only members of the network 112 that reside in Colorado, or the members that have mentioned something about lifestyle in Colorado may be selected. In an alternative implementation, the recommendation system 100 uses data from the entire network 112 in generating recommendation for the user 102. Thus, for example, even if a member in the network 112 is not located in Denver or even if such a member is not connected to the user 102, the recommendation system 100 may still use recommendations from such a member when generating a recommendation for the user 102.

The recommendation system 100 may send specific request to the provider of the network 112 for data related to the members. For example, if the network 112 is Twitter, the recommendation system 100 may send data request to an API provided by Twitter to get information about the members 112a and 112c. Alternatively, the recommendation system 100 may send specific queries to a query engine provided by the network 112, and let the query engine determine which members in the network of the user 102 are to be selected. Similarly, the recommendation system 100 may use the API or query engine provided by the organizations 116, 118, etc., to get data about service 142 in the location 140.

Once the recommendation system 100 gathers information about members of the user's networks 112, 114, etc., the recommendation system 100 processes the information to generate rankings for the service 142 near the location 140 for the user 102. For example, when the user 102 is looking for recommendations for fitness center, the recommendation system 100 analyzes the information about the members of the user's network 112, 114, and the information from the organizations 114, 116 to generate the ranking for various fitness centers in Denver. In one implementation, such ranking is generated based on recommendations for various fitness centers in Denver by the members 112a, 112b, 112c, etc., and the recommendations by the organizations 116, 118.

For example, if a member 112a, a friend of the user 102 on social network 112 may have explicitly recommended a fitness center 51 by liking the social network page of the fitness center 51. In this case, the liking by the member 112a may be used in generating recommendation RM11 for the fitness center S1. Alternatively, the member 112c may have made a positive comment on his wall on the social network 112 about the fitness center S1, in which case, the recommendation system 100 may use a text analytics method to generate the implicit recommendation RM31 for the fitness center S1. Furthermore, the recommendation system also receives and analyzes the recommendations from the various organizations. In one implementation, the recommendation system 100 may standardize each of the recommendations from the organizations to a common recommendation matrix. For example, the organization 116 may provide recommendations for fitness center S1 on a scale of 1-10, whereas the organization 118 may give recommendations for the fitness center S1 on a scale of A-F. In such a case, the recommendation system 100 standardizes the recommendations A-F to a standardized recommendation RO11 and the recommendation 1-10 to a standardized recommendation RO21.

After generating the recommendations from various members, organizations, etc., the recommendation system 100 generates weightings for each of the recommendations. For example, if the member 112a is a close friend of the user 102, the recommendation system 100 may assign a higher weight W11 to the member 112a. On the other hand, if the member 112c is not a close friend of the user 102, a lower weight W31 is assigned to the member 112a. A number of other criteria may be used in assigning such weights. For example, a social relation score may be assigned to each pair of members of the network based on past interactions between the members and such social relational score may be used to generate the weights. Alternatively, the reputation of the members in providing the recommendations, as illustrated by the endorsement of the reputations by other members of the networks, may also be used in assigning the weights.

In one implementation, the members of the networks are encouraged to provide recommendations for various services and products. In such an implementation, the quality of the recommendations is monitored by the recommendation system 100. For example, a high quality of recommendation may be determined by higher endorsement of a recommendation in the form of “likes,” positive comments, etc., on the other hand, a low quality of recommendation may be determined by lower endorsements, negative comments, etc. Furthermore, when a member of the network provides a large number of high quality recommendations, the member may be designated as a tandem member, in which case a higher weight is assigned to the recommendation from the tandem member. Furthermore, the tandem member may also be given remunerations in form of rewards, coupons, etc.

Yet alternatively, the user 102 may also be given a choice in determining how much weight is to be assigned to a particular member of the network, a particular organization, etc. For example, if the user 102 determines that the member 112c is not known for his or her recommendations for fitness centers, the weight assigned to member 112c may be lower. On the other hand, if another user (not shown) really values the recommendation provided by the member 112c for hotels, a higher weight will be assigned to hotel recommendations from member 112c when generating rankings for such another user. Similarly, the user 102 may determine that she does not like recommendations from organization 116, in which case a lower weight is assigned for all recommendations from organization O1, when generating recommendations for user 102.

In an alternative implementation, no preferences are set and therefore, average of all the data is used without applying any weights dependent on the user. Thus, for example, for a relatively new user of the recommendation system 100 or for a user that wishes to remain anonymous, recommendations may be generated using all data from the networks 112, 114, organizations 116, 118, etc. Alternatively, family relations may be used to generate weights, where sister's feedback may be provided higher weight then a friend's input. Yet alternatively, the user is provided the flexibility select or unselect family relation based weighing. In an alternative implementation, when a user is looking for a recommendation for a doctor, an input from a friend working in the healthcare field may be provided higher weight than others. The occupation of such network member may be determined based on profile of the network members in a network, semantic analysis of the member's comments, etc.

In an alternative implementation, past experiences of members are used in determining the weights. Thus, if a member has stayed at a hotel, his or her rating is provided higher weight when generating recommendation for hotels. As another example, while generating recommendations for a veterinarian, rankings from network members having a pet animal are given higher weights than rankings from other members. Similarly, when generating recommendations for a restaurant, is a network member checks-in at a restaurant quite frequently, ranking from such a member is given higher weight. Similarly, the amount of time a member has been living in an area of interest may be considered in generating weights for the member's ranking.

The recommendation system 100 uses the recommendations RM11, RM31, RO11, R021, etc., and the various weights W11, W31, WO1, WO2, etc., to be assigned to these recommendations, to generate a ranking R1, R2, R3, etc., for various fitness centers S1, S2, S3, etc. For example, the following equation may be used to generate the rank R1 for the fitness center S1:

R1=W11*RM11+W31*RM31+WO1*R011+W02*R021

Subsequently, the recommendation system 100 communicates the rankings R1, R2, R3 to the device 104. A GUI 130 may be used to display the rankings for various fitness centers S1, S2, S3 to the user 102 using the GUI 130. For example, as illustrated in FIG. 1, the ranking R1 of 78 is listed next to the listing of the fitness center S1. The display of the fitness center S1 on the GUI 130 may be such that a user may get further information about the fitness center S1 by selecting the icon, listing, URL, etc., of the fitness center S1 on the GUI 130. Furthermore, the GUI 130 may also display information about the members 112a, 112c, etc., that provided recommendations that are used in generating the ranking R1. For example, the user may select such information about the members 112a, 112c, on the GUI 130 to get further information about such members, to communicate with such members, etc. In an alternative implementation, the GUI 130 may also disclose a link (not shown) that can be selected by the user 102 to see the methodology used in generating the rankings R1, R2, R3, etc.

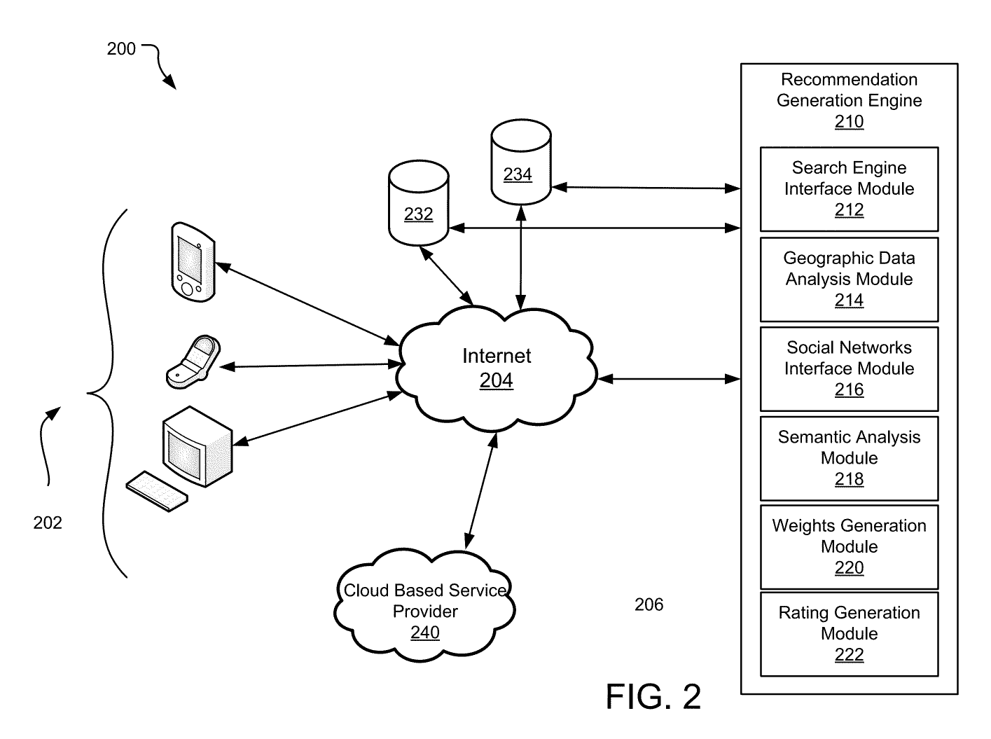

FIG. 2 discloses a block diagram of an example implementation of the recommendation system 200 disclosed herein. The recommendation system 200 allows users using user devices 202 such as a cell phone, a tablet, a computer, etc., to use the recommendation system 200. Specifically, user devices 202 may connect with the recommendation system 200 using the Internet 204, a private network such as a virtual private network (VPN), etc. The user devices 202 may include one or more programs, applications, user interface, etc., thereon, where such programs, applications or user interfaces allows the user to interact with various components of the recommendation system 200. For example, an app based on the Android™ operating system or iOS™ operating system may be used by the user device 202 to interact with the recommendation system 200. The recommendation system 200 also includes a recommendation generation engine 210 that generates recommendations for various services as per users' requests.

In one implementation, the recommendation engine 210 is implemented on a server that is communicatively connected to the Internet and other communication networks such that various users can access the services provided by the recommendation system 200. While FIG. 2 illustrate the recommendation generation engine 210 as being implemented on a single server, in an alternative implementation, such recommendation engine 210 may be implemented on a distributed server system, a cloud based computing system, etc. The recommendation engine 210 is illustrated as having various modules for performing one or more tasks necessary for generating service and product recommendations based on location. In an alternative implementation, one or more of these modules may also be implemented on alternate servers, cloud, etc. Such cloud-based service may be implemented on a cloud based service provider 240. Alternatively, such cloud-based services may be sub-routines of other program modules.

The example implementation of the recommendation engine 210 includes a search engine interface module 212 that interacts with one or more search engines, such as Google™, Yahoo™, Bing™, etc., to generate data about various services and products. For example, when a user inquires about health clubs in Santa Monica, the search engine interface module 212 interacts with one or more search engines to find out information about the health clubs in Santa Monica. Alternatively, the search engine interface module 212 may interface with a search database 234 that has information about various services and products based on previous search results received by the search engine interface module 212. Furthermore, the recommendation generation engine 210 may also include a database to store information about various services and products, as well various outputs generated by one or more of the modules 212-222.

A geographic data analysis module 214 determines whether the list of health clubs generated by the search engine interface module 212 is within a distance as requested by the user. A social networks interface module 216 interacts with one or more social networks to generate information about other users connected to the user requesting the information. In one example implementation, the user can select, using a user interface, which social networks should be accessed by the social networks interface module 216. Thus, while searching for restaurants in Santa Monica, Mary may specify that she would like reviews, recommendations, and ratings from her friends on Facebook™ and her followers on Twitter™. In such a case, the social networks interface module 216 may access a social network database 232 directly or via the Internet 204 to get data about reviews and recommendations provided by various users that are connected, directly or indirectly, with Mary on Facebook™ and Twitter™.

In one example implementation, a semantics analysis module 218 reviews and analyzes various ratings, reviews, recommendations, etc. For example, the semantics analysis module 218 may analyze the language in the reviews and recommendations provided by the users to generate information about their mood, the quality of the service or product being reviewed, etc. Thus, the semantics analysis module 218 may determine that a reviewer that describing a restaurant's food as “tasteless” may be giving a low rating to the restaurant. In other words, semantic analysis may be used to quantify the value of the review so that it can be mathematically converted to a number or numbers for the review. For example, a paragraph long review can generate couple of key points that can mathematically converted to a value. Thus, if a person says “tasteless food but good service,” the value would be different than “tasteless food, and dirty plates, and long waiting times,” etc.

A weights generation module 220 generates weights to be assigned to recommendations by various reviewers. For example, the weight generation module assigns a higher weight to a user Jim who is directly connected to Mary, whereas it assigns lower weight to Joe who is not directly connected to Mary by any social network. Alternatively, the weight generation module also assigns weights based on the reputation of a reviewer, credibility of a reviewer, etc.

A rating generation module 222 uses the ratings and the weights to generate a weighted recommendation for a service or a product. Following table is an example of such a table that illustrates an example of such weighted rating for a health club in Santa Monica:

Rating for 24 Hr Fitness on Santa Monica Blvd., Santa Monica

| Reviewer | Rating | Weight | Weighted Rating | Contribution |
|---|---|---|---|---|
| Jim | 60% | 90% | 54% | 27 |
| Johnny | 90% | 50% | 45% | 22.5 |

| | |
|---|---|
| Final Rating | 49.5 |

In the table above, Jim and Johnny two of the reviewers providing the reviews or ratings. For example, as per information from Facebook™, Jim is a close friend of Mary, therefore his review is given a higher weight (90%). On the other hand Johnny is a bad reviewer of health clubs, therefore, his rating is provided low weight (50%). The weighted ratings of all users are divided by the number of reviewers, in this case—two, to get the contribution to the final rating. The rating generation module 222 may present the rating of the 24 Hr Fitness as being 49.5 on a scale of 1 to 100.

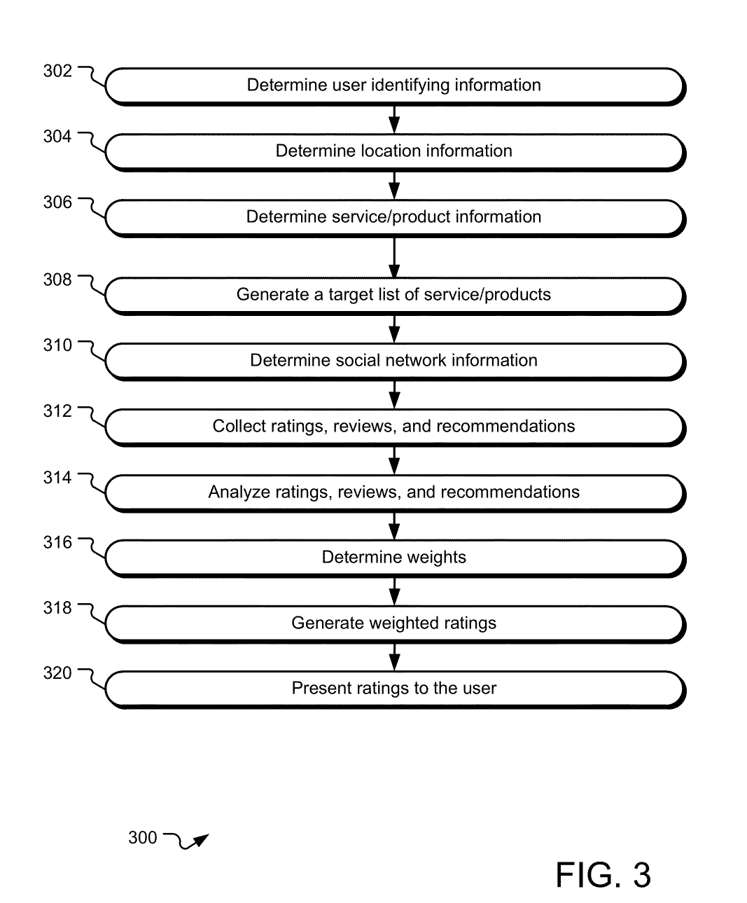

FIG. 3 illustrates an example flowchart 300 of various operations performed by the recommendation system disclosed herein. Note that while FIG. 3 presents various operations in a given order, in an alternate implementation the order of the operations may be different. Also one or more of the operations may be combined, omitted, etc. Specifically, an operation 302 determines various user-identifying information. For example, the operation 302 may determine the information about the user based on the user's login information, information received from the user's smart device, cell phone, etc. An operation 304 determines the geographic location in which the user is interested. The user can provide such information by typing the name of the location or zip code, by providing such information using a map application interface, by using an audio application interface, such as Siri™, etc. Yet alternatively, GPS, cellular phone towers, etc., may also be used to determine the location of the device used by the user. Subsequently, the current location of the device may be selected as the geographic location of interest.

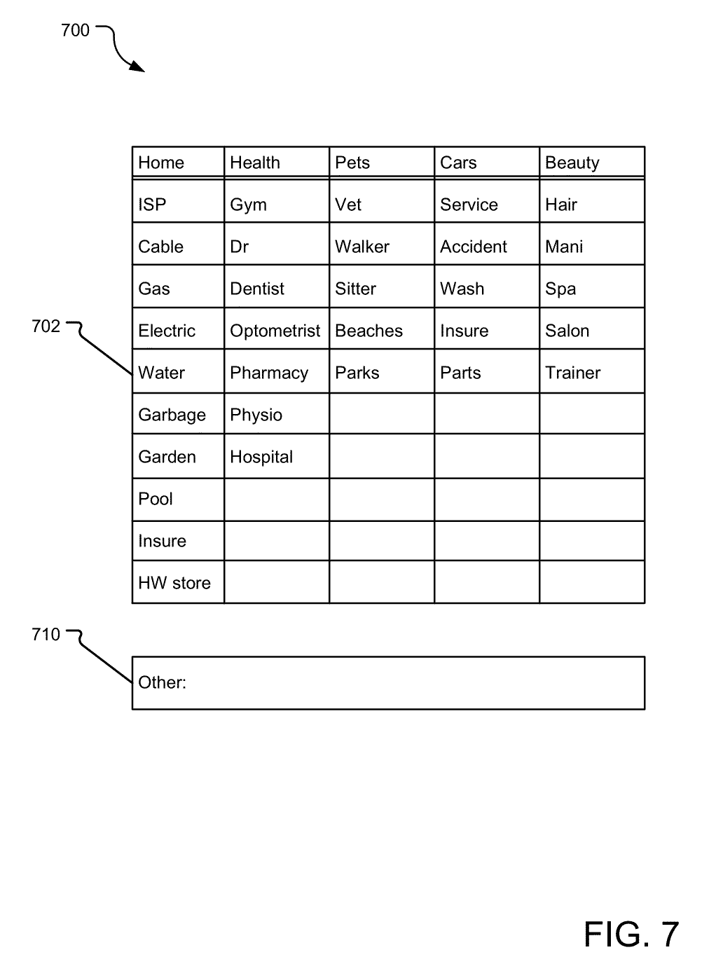

Similarly, an operation 306 determines the services and/or products for which the user needs recommendations. The user may be provided a drop down menu, a listing of services, etc., that can be used to provide the service/product information. (See FIG. 7). Based on the location information and the service/product information, an operation 308 may generate a target list of products/services. Thus, if the operation 304 determines Silver Lake, Calif. as the location and the operation 306 determines Restaurants as the service, the operation 308 will generate a target list of restaurants in Silver Lake. In an alternative implementation, the operation 308 may also consider other factors, such as Mary's preference for the type of food, Mary's income level, etc., in generating the list of target restaurants In one implementation, information on Mary's preferences is sourced from her profile information on Facebook™ and other sources. These preferences may be used by the application to weight suggested services and/or products.

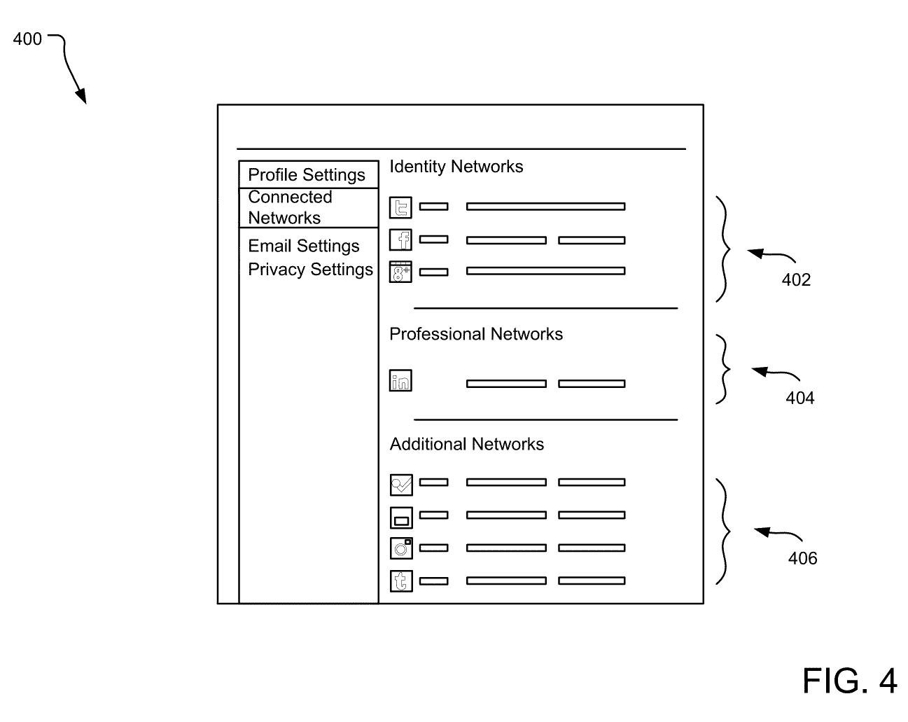

An operation 310 determines the social network information of a user. For example, a user may be provided a menu for selecting such social networks (see FIG. 4). Alternatively, the user's social network information is determined automatically based on information received from the user's smartphone, etc. For example, if Mary is using an iPhone™ with an app for Facebook™ and Twitter™ installed on the iPhone™, the operation 310, given the permissions, collects information about the Facebook™ and Twitter™ from the iPhone™.

An operation 312 collects various ratings, reviews, recommendations, etc., from the people that are directly or indirectly connected to Mary. Thus, ratings, reviews, recommendations, etc., from Mary's friends from Facebook™, her followers on Twitter™, the users being followed by Mary on Twitter™, etc., is collected. The operation 314 analyzes such data to determine rating for each service/product from the target listing of services/products to generate ratings provided by each user. An operation 316 determines the weights to be assigned to each rating. For example, such weights are assigned based on the user's reputation, how closely the user is connected to Mary, etc. An operation 318 uses the ratings and the weights to generate the weighted ratings for the services/products on the target list. An operation 320 presents such weighted rating to the user via the cellular phone, tablet, computer, etc.

FIG. 4 illustrates a user interface 400 that may be used by the recommendation system to collect information from a user. The interface 400 may be provided to the user at the time the user is initially signing up with the recommendation system disclosed herein. For example, the interface 400 may be provided using an app on a mobile device or via a website that can be accessed by using a laptop, computer, mobile device, etc. Specifically, the interface 400 allows the user to select one or more networks or organizations that will be used in collecting information that is used in generating location based recommendations and rankings. For example, the interface 400 provides a list of identity networks (social networks) 402, such as a Facebook, Twitter, etc., that a user can select. In one implementation, the interface 400 may also allow the user to login to the recommendation system using one of the identity networks. Similarly, one or more professional networks 404 (e.g., LinkedIn™, etc.) and additional networks 406 (e.g., FourSquare™, etc.) are also provided for the user to select.

The user may be encouraged to select as many of his/her existing social networks they participate in to allow the application to source recommendations from the vast number of sources. Once the user selects one or more of the networks 402, 404, 406, the recommendation system collects data about the user's network, members of the network that are connected to the user, past information posted by the user and the members on these networks, etc. Alternatively, the recommendation system connects with these networks using API, query engine, etc., and sends requests for data in real-time as necessary. The interface 400 also allows the user to set the user profile, privacy settings, e-mail settings, means of communication and notifications to be received by the user, etc.

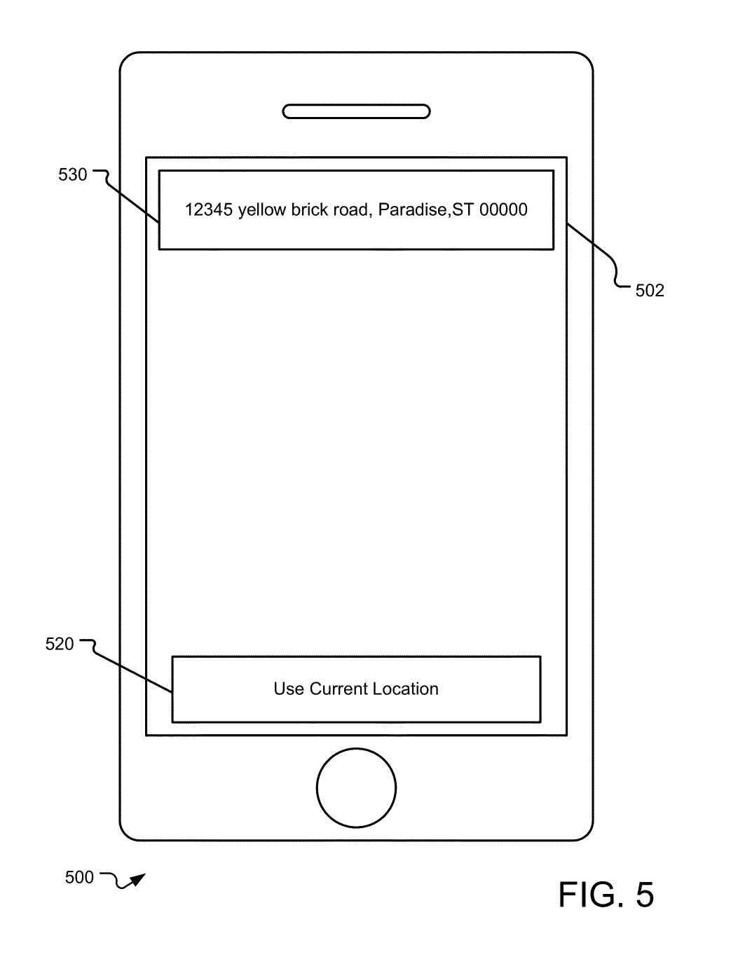

FIG. 5 illustrates a smartphone 500 for receiving location information from a user. Specifically, a user interface 502 allows a user to select a button 520 or provide address of a location in an input box 530 to identify a location. Thus, for example, if a user in NY and if she wants information about services close to the yellow brick road in Paradise, she can provide the address using the input option 530. Alternatively, if Mary is already on the yellow brick road in Paradise, she can simply select the button 520 to identify the location. In an alternative implementation, Mary may be provided with options for the location input option 530 based on information that is known about Mary from one or more of the networks selected by Mary. If Mary selects the current location option 520, the recommendation system uses an interface to a GPS (or other means of determining location) to determine the current location.

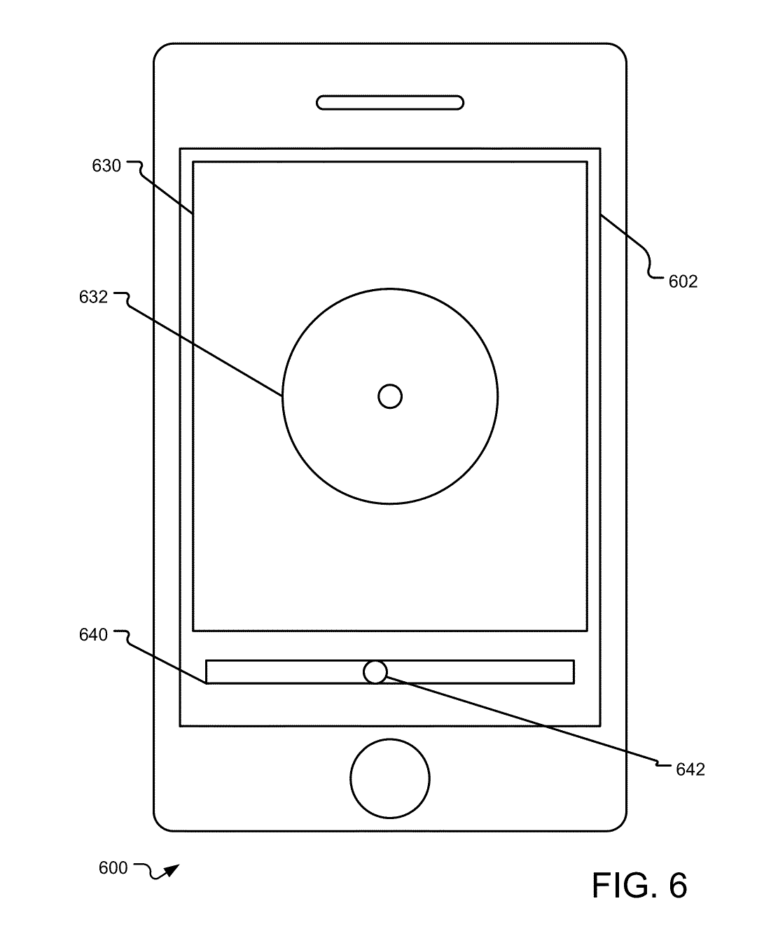

FIG. 6 illustrates a smartphone 600 providing an interface 602. Specifically, the smartphone 600 provides a user interface 602 that allows a user to select a location on the map 630 and provide area or interest 632. Thus, for example, the user may use touch interface to select location on the map 630 and expand it to the area of interest 632. Alternatively, the user may also use interface 640 that provides a sliding button 642 that may be moved by the user to expand or reduce the area of interest 632.

Once the location of interest is determined, either through the input option 530, or through the input option 520, the recommendation system uses that location information to analyze data collected from the various networks, organizations, etc., to generates recommendations and rankings for Mary.

FIG. 7 illustrates a list of services (products) 700 that a user can select. For example, the user can click on the listing of “water” 702 for the recommendation system to generate recommendation about water services. The list of services 700 may be generated using an analysis of the user's network activity. For example, if such analysis determines that the user has been discussing an impending move to another location, services that will be useful for someone moving to a new location, such as utility services, etc., are provided on the list of services 700. Alternatively, if the user has been discussing going to college on a new location, listing of services 700 may include information about colleges, bookstores, college supplies, etc., more prominently on the list of services.

In an alternative implementation, the user is also provided an input option 710 for providing information about other services. The user may select the input option 710 for providing information about such other service of interest. In one implementation, when the user selects the input option 710, a keyboard or other user input option is provided.

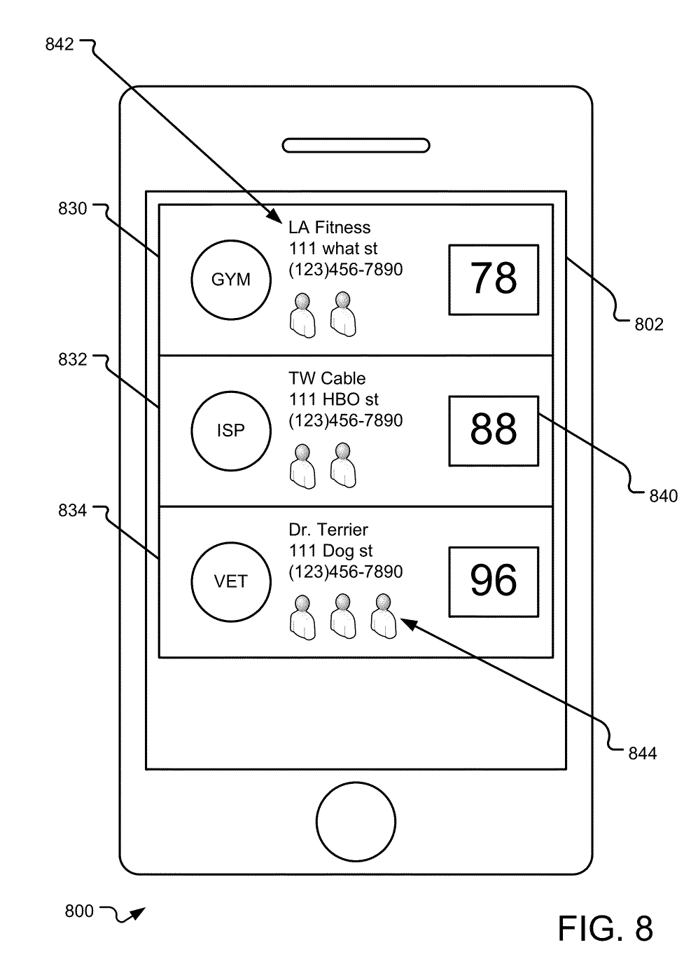

FIG. 8 illustrates a smartphone 800 with a user interface 802 that may be used to present one or more recommendations to the user. Specifically, FIG. 8 illustrates a recommendation 830 for a gymnasium (GYM), a recommendation 832 for an Internet service provider (ISP), and a recommendation 834 for a veterinarian (VET). For example the recommendation 830 includes the rating or score for LA Fitness and the address and phone number 842 for LA Fitness. Furthermore, the recommendation 830 also includes the pictures of the members of the user's network that provided recommendation and rating for LA Fitness. A user can select one of these pictures or icons to get further detail about the recommendation provided by that particular user. Similarly, the recommendation 832 provides the recommendation for an ISP service and a score 840 of 88 for the recommendation. In one implementation, the score 840 of 88 is provided on a scale of 0 to 100 with 100 being the best score and 0 being the least score. However, in an alternative implementation other alphanumeric ranking may be provided. Furthermore, the recommendation 834 also provides one or more icons 844 of the members of the user's network. The user may select such icons 844 to find out more about the members, to see their comments on the recommendation, etc. Yet alternatively, the icons 844 may also be selected to open another application, such as e-mail, texting, etc., to communicate with such members.

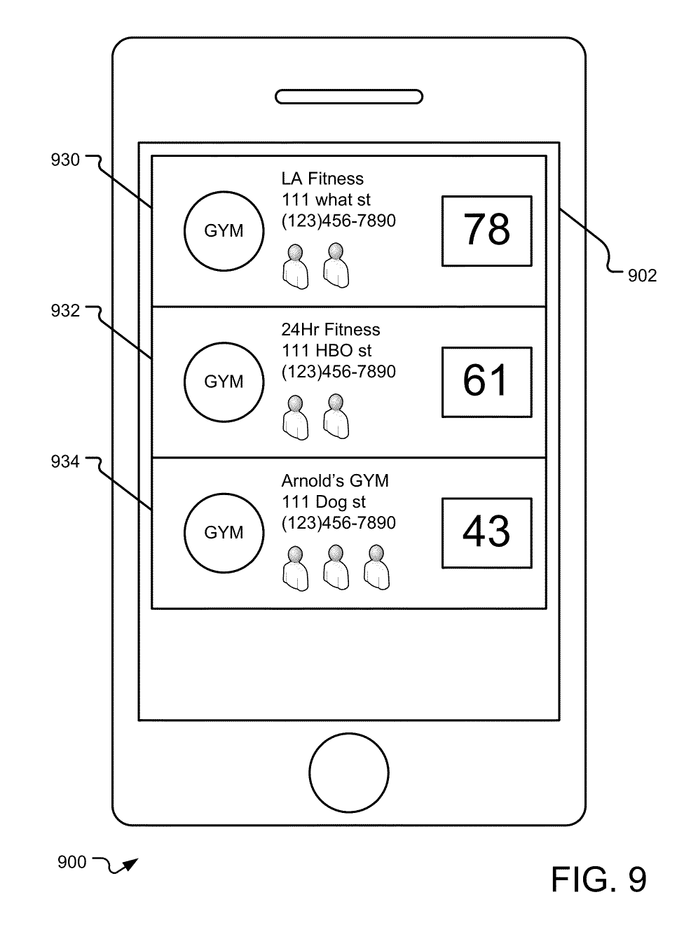

FIG. 9 illustrates a smartphone 900 with a user interface 802 that may be used to present one or more recommendations for a same service, such as fitness centers, to the user. Specifically, FIG. 9 illustrates a recommendation 930 for LA Fitness, a recommendation 932 for 24 Hr Fitness, and a recommendation 934 for Arnold's GYM. As illustrated, the user is provided the listing of various service providers based on the ratings in descending order. Each of the recommendations 930-934 also includes further information such as score, address and contact information about the service provider, list of icons representing network members that recommended the service provider, etc.

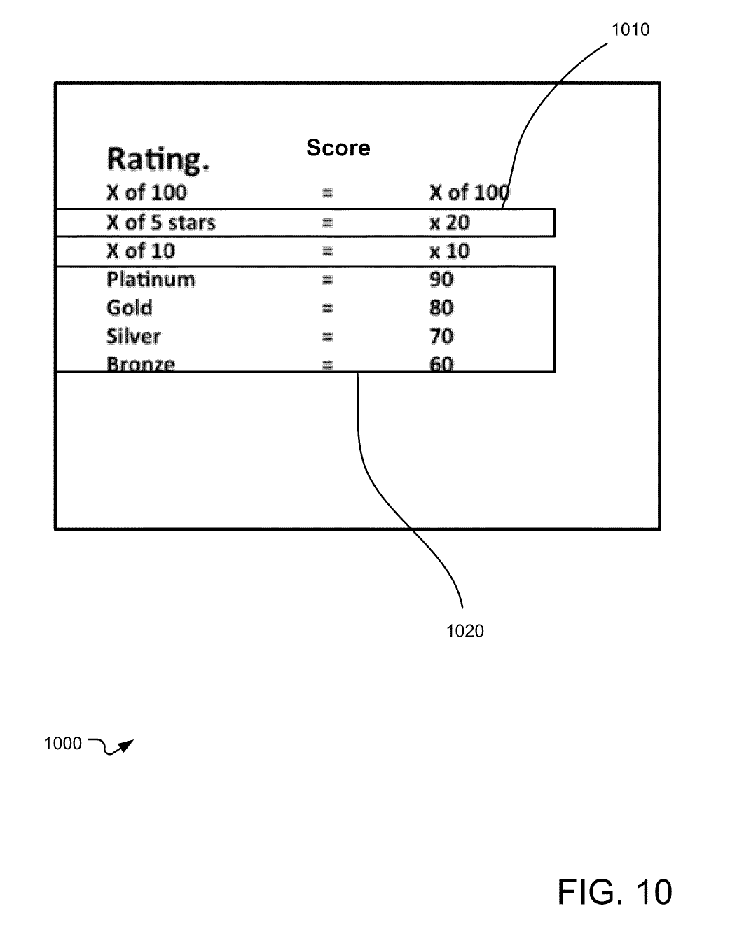

FIG. 10 illustrates a rating generator table 1000 used by a ranking engine of the recommendation system. Specifically, the rating generator table converts rating provided by a user or an organization to a score that can be used in calculating the rankings for service or products. For example, if a user has provided ratings 1010 for a service on a scale or one star to five stars, with five stars being the highest, the ranking engine may multiply each star rating by 20 to generate ranking on a scale of 1 to 100. Similarly, if a user is providing rating 1020 based on platinum, gold, silver, and bronze, the rating engine may assign a score of 90, 80, 70, and 60, respectively to such rating to generate rankings on a scale of 1 to 100. Thus, for example, a rating of Gold is converted to a score of 80.

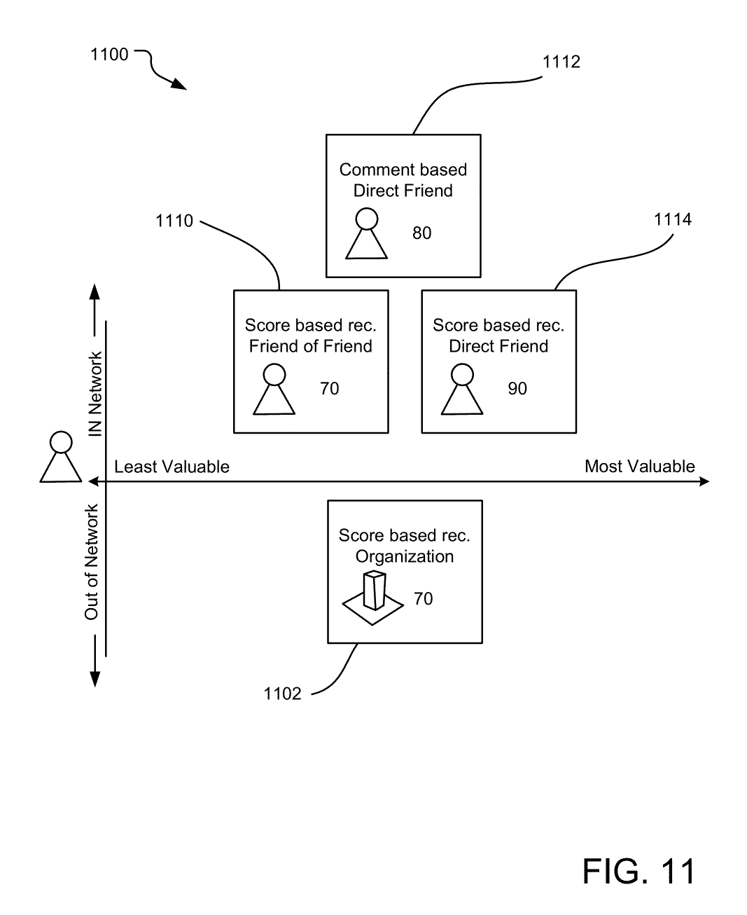

FIG. 11 illustrates a diagram 1100 illustrating generating weights to be applied to a score for a service as provided by a user's recommendation. Specifically, FIG. 11 illustrates that a user that is out of network is given lower weight. Thus, a score for a service 1102 from Yelp™ is given lower score. Compared to that, recommendations from members 1110, 1112, 1114, in the network are given a higher weight. On the other hand, for reviewers in the network, a member 1114 that is directly connected to a user is given a higher weight of 90 whereas a member 1110, who is a friend of a friend of the user is given a lower weight of 70. In one implementation, the more disconnected a source of recommendation is from the user the less may be the weight assigned to recommendations from that user. In an alternative implementation, as long as the source offers some form of recommendation, such recommendation is incorporated into the final score. The score generated as per FIG. 10 may be multiplied by the weighting as per FIG. 11 to generate the weighted score for a service or product.

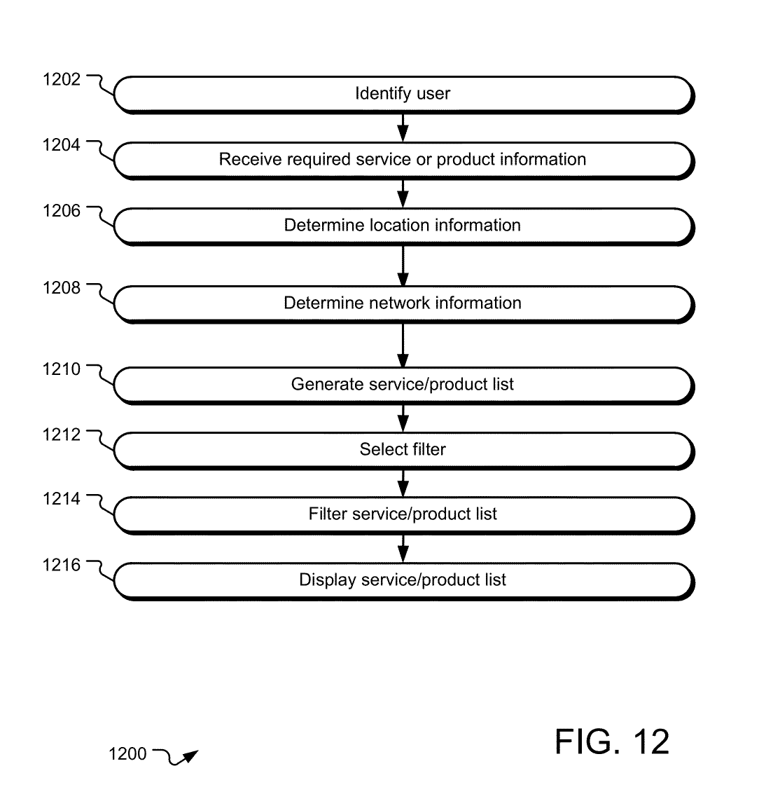

FIG. 12 illustrates an example flowchart 1200 for generating location based recommendations. Specifically, an operation 1202 identifies a user using the user device, user login, user's login into a network selected by the user, etc. Subsequently, an operation 1204 receives the required service or product information from the user. For example, the user may give such service information using a graphical user interface on a website, a mobile application, a verbal command, etc. An operation 1206 determines the location information based on the current location of the user or based on information provided by the user. An operation 1208 determines the networks that will be used to collect data used for generating recommendations and rankings. For example, the user provides the networks via a user interface. An operation 1210 generates the list of services and products for the selected location for the user. For example, if the user is interested in a list of ISPs, the operation 1210 generates a list of all ISPs in and around the location provided by the user.

Subsequently, an operation 1212 selects a filter that will be used to filter the services or products. For example, such filter may include price information, distance from the selected location, lowest rating provided by members of the network, etc. In an alternative implementation, a general minimum rating of the whole database, or combined data may be used without applying any personal filters. Yet alternatively, reviews that have a minimum numbers of reviewers attached thereto are used for generating recommendations. Thus, reviews from anonymous reviewers are neglected in generating the recommendation.

An operation 1214 uses the filter to filter the list of services and products. The filtered list is displayed to the user by an operation 1216. For example, such as list may be displayed on a mobile device, a web page, etc.

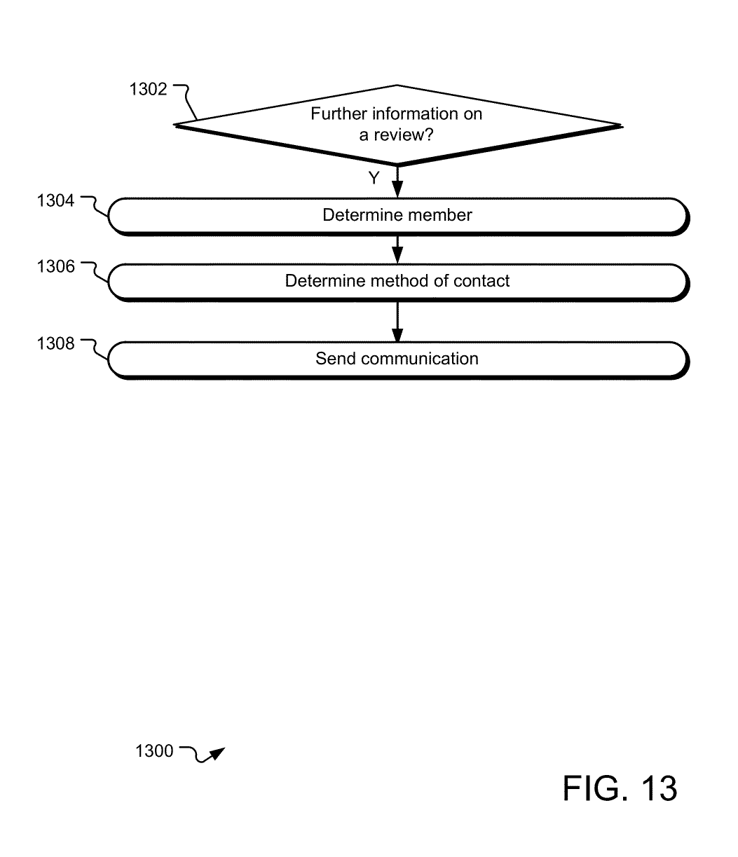

FIG. 13 illustrates an example flowchart 1300 for providing detailed review information to users. An operation 1302 determines if further information on a review or a rating is to be presented. For example, the operation 1302 makes such a decision in response to a selection by a user on a user interface displaying the recommendations and rankings for a service. An operation 1304 determines the network member that provided ratings or recommendation for a service displayed to the user on the service listing. For example, the member may be determined based on an input from a user on a user interface, etc. Subsequently, an operation 1306 determines the method of contact between the user of the recommendation system and the network member. The operation 1306 may use the preferred communication methods of both the user and the network member in generating such method of contact. For example, if both the user and the member prefer communicating via text messages, an application that allows text messaging is initiated. An operation 1308 uses the selected communication method to send a communication.

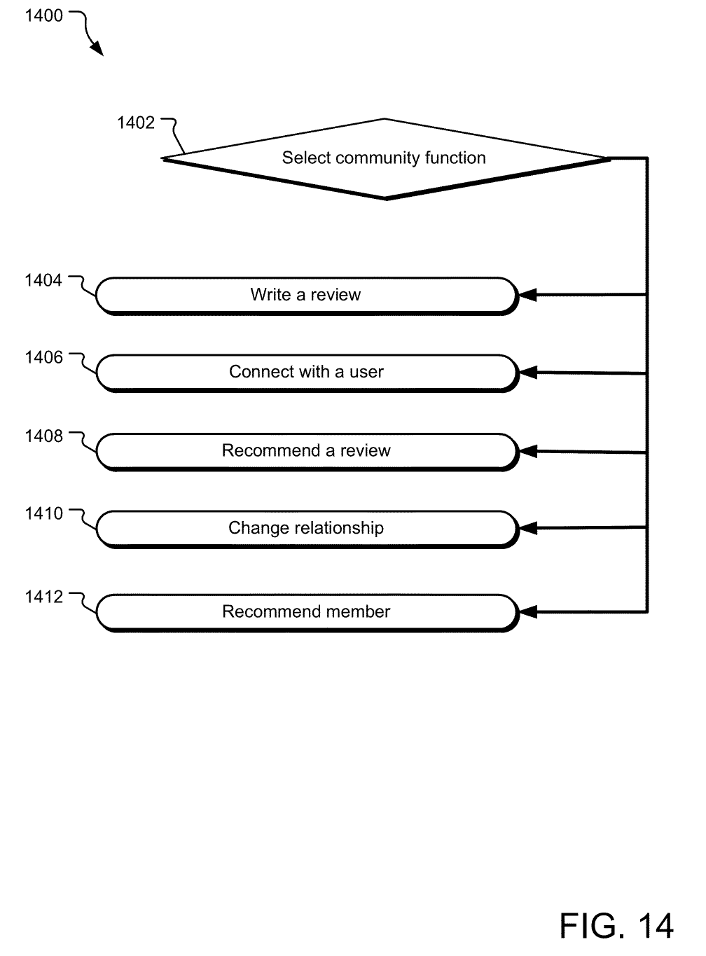

FIG. 14 illustrates an example flowchart 1400 for providing community functions for various users in the location based recommendation system. An operation 1402 selects the community function to be provided using the recommendation system. Such community functions are presented to members of networks used by the recommendation system. For example, an operation 1404 allows members to write a review on various service and products. An operation 1406 allows members of networks to connect with other users of the recommendation system. An operation 1408 recommends a review of a product or service to other members. An operation 1410 changes relationship between two members of a network and operation 1412 recommends a member to other members of the networks used by the recommendation system. While the example flowchart 1400 discloses an implementation where various users are able to communicate with each other, such communication between the users may be conditional on the communication settings of the various users. Thus, for example, some users may elect not to receive such communications

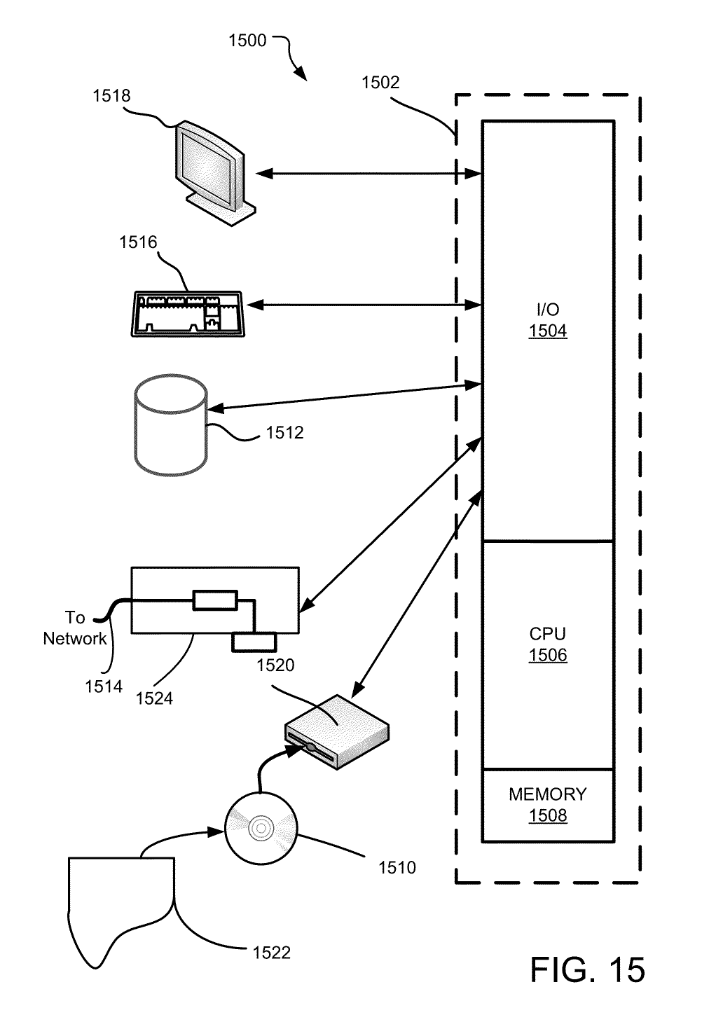

FIG. 15 illustrates an example computing system that can be used to implement one or more components of the recommendation method and system described herein. A general-purpose computer system 1500 is capable of executing a computer program product to execute a computer process. Data and program files may be input to the computer system 1500, which reads the files and executes the programs therein. Some of the elements of a general-purpose computer system 1500 are shown in FIG. 15, wherein a processor 1502 is shown having an input/output (I/O) section 1504, a Central Processing Unit (CPU) 1506, and a memory section 1508. There may be one or more processors 1502, such that the processor 1502 of the computer system 1500 comprises a single central-processing unit 1506, or a plurality of processing units, commonly referred to as a parallel processing environment. The computer system 1500 may be a conventional computer, a distributed computer, or any other type of computer such as one or more external computers made available via a cloud computing architecture. The described technology is optionally implemented in software devices loaded in memory 1508, stored on a configured DVD/CD-ROM 1510 or storage unit 1512, and/or communicated via a wired or wireless network link 1514 on a carrier signal, thereby transforming the computer system 1500 in FIG. 15 to a special purpose machine for implementing the described operations.

The I/O section 1504 is connected to one or more user-interface devices (e.g., a keyboard 1516 and a display unit 1518), a disk storage unit 1512, and a disk drive unit 1520. Generally, in contemporary systems, the disk drive unit 1520 is a DVD/CD-ROM drive unit capable of reading the DVD/CD-ROM medium 1510, which typically contains programs and data 1522. Computer program products containing mechanisms to effectuate the systems and methods in accordance with the described technology may reside in the memory section 1504, on a disk storage unit 1512, or on the DVD/CD-ROM medium 1510 of such a system 1500, or external storage devices made available via a cloud computing architecture with such computer program products including one or more database management products, web server products, application server products and/or other additional software components. Alternatively, a disk drive unit 1520 may be replaced or supplemented by a floppy drive unit, a tape drive unit, or other storage medium drive unit. The network adapter 1524 is capable of connecting the computer system to a network via the network link 1514, through which the computer system can receive instructions and data embodied in a carrier wave. Examples of such systems include Intel and PowerPC systems offered by Apple Computer, Inc., personal computers offered by Dell Corporation and by other manufacturers of Intel-compatible personal computers, AMD-based computing systems and other systems running a Windows-based, UNIX-based, or other operating system. It should be understood that computing systems may also embody devices such as Personal Digital Assistants (PDAs), mobile phones, smart-phones, gaming consoles, set top boxes, tablets or slates (e.g., iPads), etc.

When used in a LAN-networking environment, the computer system 1500 is connected (by wired connection or wirelessly) to a local network through the network interface or adapter 1524, which is one type of communications device. When used in a WAN-networking environment, the computer system 1500 typically includes a modem, a network adapter, or any other type of communications device for establishing communications over the wide area network. In a networked environment, program modules depicted relative to the computer system 1500 or portions thereof, may be stored in a remote memory storage device. It is appreciated that the network connections shown are exemplary and other means of and communications devices for establishing a communications link between the computers may be used.

Further, the plurality of internal and external databases, data stores, source database, and/or data cache on the cloud server are stored as memory 1508 or other storage systems, such as disk storage unit 1512 or DVD/CD-ROM medium 1510 and/or other external storage device made available and accessed via a cloud computing architecture. Still further, some or all of the operations for the system for recommendation disclosed herein may be performed by the processor 1502. In addition, one or more functionalities of the system disclosed herein may be generated by the processor 1502 and a user may interact with these GUIs using one or more user-interface devices (e.g., a keyboard 1516 and a display unit 1518) with some of the data in use directly coming from third party websites and other online sources and data stores via methods including but not limited to web services calls and interfaces without explicit user input.

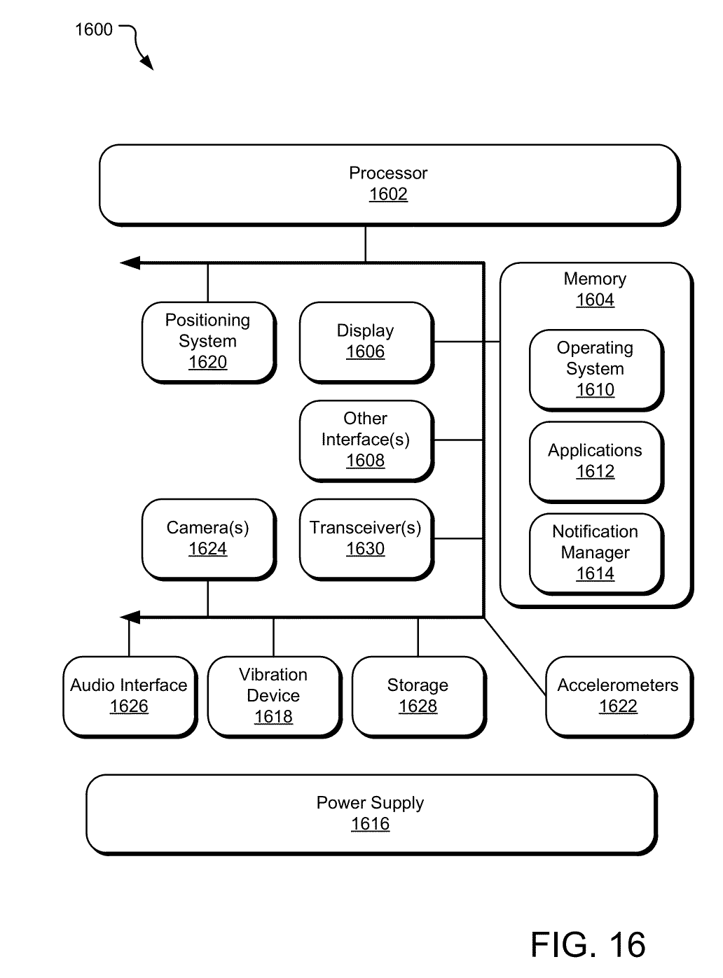

FIG. 16 illustrates an example mobile computing device 1600 that can be used to implement one or more components of the recommendation system disclosed herein. Specifically, the mobile computing device 1600. The mobile device 1600 includes a processor 1602, a memory 1604, a display 1606 (e.g., a touchscreen display), and other interfaces 1608 (e.g., a keyboard). The memory 1604 generally includes both volatile memory (e.g., RAM) and non-volatile memory (e.g., flash memory). An operating system 1610, such as the Microsoft Windows® Phone 7 operating system, resides in the memory 1604 and is executed by the processor 1602, although it should be understood that other operating systems may be employed.

One or more application programs 1612 are loaded in the memory 1604 and executed on the operating system 1610 by the processor 1602. Examples of applications 1612 include without limitation email programs, scheduling programs, personal information managers, Internet browsing programs, multimedia player applications, etc. In one implementation, an recommendation application stored in the memory 1604 may be used to catalog various observations stored on the mobile device 1600, such as e-mail addresses from the e-mail application of the mobile device, the contacts from a contact management application stored on the mobile device 1600, etc. In yet alternate implementation, a client application stored in the memory 1604 of the mobile device 1600 may generate queries using the information stored on the mobile device 1600, receive entity relation information from a server generating relations between various elements, and display updated observations to a user of the mobile device 1600. A notification manager 1614 is also loaded in the memory 1604 and is executed by the processor 1602 to present notifications to the user. For example, when a promotion is triggered and presented to the shopper, the notification manager 1614 can cause the mobile device 1600 to beep or vibrate (via the vibration device 1618) and display the promotion on the display 1606.

The mobile device 1600 includes a power supply 1616, which is powered by one or more batteries or other power sources and which provides power to other components of the mobile device 1600. The power supply 1616 may also be connected to an external power source that overrides or recharges the built-in batteries or other power sources.

The mobile device 1600 includes one or more communication transceivers 1630 to provide network connectivity (e.g., mobile phone network, Wi-Fi®, BlueTooth®, etc.). The mobile device 1600 also includes various other components, such as a positioning system 1620 (e.g., a global positioning satellite transceiver), one or more accelerometers 1622, one or more cameras 1624, an audio interface 1626 (e.g., a microphone, an audio amplifier and speaker and/or audio jack), and additional storage 1628. Other configurations may also be employed.

Embodiments of the present technology are disclosed herein in the context of a recommendation system. In the above description, for the purposes of explanation, numerous specific details are set forth in order to provide a thorough understanding of the present invention. It will be apparent, however, to one skilled in the art that the present invention may be practiced without some of these specific details. For example, while various features are ascribed to particular embodiments, it should be appreciated that the features described with respect to one embodiment may be incorporated with other embodiments as well. By the same token, however, no single feature or features of any described embodiment should be considered essential to the invention, as other embodiments of the invention may omit such features.

In the interest of clarity, not all of the routine functions of the implementations described herein are shown and described. It will, of course, be appreciated that in the development of any such actual implementation, numerous implementation-specific decisions must be made in order to achieve the developer's specific goals, such as compliance with application—and business-related constraints, and that those specific goals will vary from one implementation to another and from one developer to another.

According to one embodiment of the present invention, the components, process steps, and/or data structures disclosed herein may be implemented using various types of operating systems (OS), computing platforms, firmware, computer programs, computer languages, and/or general-purpose machines. The method can be run as a programmed process running on processing circuitry. The processing circuitry can take the form of numerous combinations of processors and operating systems, connections and networks, data stores, or a stand-alone device. The process can be implemented as instructions executed by such hardware, hardware alone, or any combination thereof. The software may be stored on a program storage device readable by a machine.

According to one embodiment of the present invention, the components, processes and/or data structures may be implemented using machine language, assembler, C or C++, Java and/or other high level language programs running on a data processing computer such as a personal computer, workstation computer, mainframe computer, or high performance server running an OS such as Solaris® available from Sun Microsystems, Inc. of Santa Clara, Calif., Windows Vista™, Windows NT®, Windows XP PRO, and Windows® 2000, available from Microsoft Corporation of Redmond, Wash., Apple OS X-based systems, available from Apple Inc. of Cupertino, Calif., or various versions of the Unix operating system such as Linux available from a number of vendors. The method may also be implemented on a multiple-processor system, or in a computing environment including various peripherals such as input devices, output devices, displays, pointing devices, memories, storage devices, media interfaces for transferring data to and from the processor(s), and the like. In addition, such a computer system or computing environment may be networked locally, or over the Internet or other networks. Different implementations may be used and may include other types of operating systems, computing platforms, computer programs, firmware, computer languages and/or general purpose machines; and. In addition, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein.

In the context of the present invention, the term “processor” describes a physical computer (either stand-alone or distributed) or a virtual machine (either stand-alone or distributed) that processes or transforms data. The processor may be implemented in hardware, software, firmware, or a combination thereof.

In the context of the present technology, the term “data store” describes a hardware and/or software means or apparatus, either local or distributed, for storing digital or analog information or data. The term “Data store” describes, by way of example, any such devices as random access memory (RAM), read-only memory (ROM), dynamic random access memory (DRAM), static dynamic random access memory (SDRAM), Flash memory, hard drives, disk drives, floppy drives, tape drives, CD drives, DVD drives, magnetic tape devices (audio, visual, analog, digital, or a combination thereof), optical storage devices, electrically erasable programmable read-only memory (EEPROM), solid state memory devices and Universal Serial Bus (USB) storage devices, and the like. The term “Data store” also describes, by way of example, databases, file systems, record systems, object oriented databases, relational databases, SQL databases, audit trails and logs, program memory, cache and buffers, and the like.

The above specification, examples and data provide a complete description of the structure and use of exemplary embodiments of the invention. Although various embodiments of the invention have been described above with a certain degree of particularity, or with reference to one or more individual embodiments, those skilled in the art could make numerous alterations to the disclosed embodiments without departing from the spirit or scope of this invention. In particular, it should be understand that the described technology may be employed independent of a personal computer. Other embodiments are therefore contemplated. It is intended that all matter contained in the above description and shown in the accompanying drawings shall be interpreted as illustrative only of particular embodiments and not limiting. Changes in detail or structure may be made without departing from the basic elements of the invention as defined in the following claims.

1. A method of, comprising:
ranking a service provider or a product for a user based on scorings of the service provider by one or more members of a network of the user and weights assigned to each of the scorings, wherein the weights are determined based on the user.

2. The method of claim 1, wherein the weights are determined by the user.

3. The method of claim 1, wherein the members of the network are selected based on a location selected by the user.

4. The method of claim 1, wherein the members of the network are selected based on an input from a user.

5. The method of claim 1, wherein the members of the network are selected based on a social relation score between the user and the members.

6. The method of claim 1, wherein the weights are selected based on a social relation score between the user and the members.

7. The method of claim 1, wherein the weights are determined based on approval of the scoring by other users of the network.

8. The method of claim 1, further comprising:
generating an organizational scoring for the service provider using review of the service by an organization;
generating an organizational weight to be assigned to the organizational scoring; and
revising the ranking based on the organizational scoring and the organizational weight.

9. The method of claim 8, wherein the organization is selected based on a user input.

10. The method of claim 1, further comprising generating a rating of one or more members of a network based on approval of the scoring provided by the one or more members of a network by other users.

11. The method of claim 1, further comprising:
selecting a listing of service providers based on ranks assigned to the service providers;
associating one or more members of the network with one or more of the selected service providers; and
displaying the listing of service providers, the ranks assigned to the service providers, and one or more members of the network associated with the service providers.

12. The method of claim 11, wherein the listing of service providers is displayed in a user selectable form such that the user can communicate with the service provider by selecting the service provider from the listing.

13. The method of claim 11, wherein the ranks assigned to the service providers are displayed in a user selectable form such that the user can select to rank to display a methodology used in generating the rank.

14. The method of claim 11, wherein the one or more members of the network associated with the service providers are displayed in a user selectable form such that the user can communicate with the one or more members by selecting the one or more members.

15. A method. Comprising:
determining a geographic location of interest to a user;
determining a product of interest to the user;
selecting various members interconnected to the user using the geographic location of interest and the product of interest;
determining information related to the selected members;
generating a service recommendation for the product based on information related to the selected members; and
assigning a status to one of the selected members based on quality of recommendations made by that one of the selected members.

16. The method of claim 15, further comprising selecting the various members based on past interactions between the members and the user.

17. The method of claim 15, wherein the various members are interconnected to the user via one or more social networks.

18. The method of claim 15, wherein determining the various members further comprises determining the various members based on recommendation reputation of the various members.

19. The method of claim 15, wherein the information related to the various members further comprises recommendations from the various members about the product.

20. The method of claim 15, further comprising determining a ranking of various providers for the product.

21. One or more computer-readable storage media encoding computer-executable instructions for executing on a computer system a computer process, the computer process comprising:
determining a geographic location of interest to a user;
determining a product of interest to the user;
selecting various network members interconnected to the user using the geographic location of interest and the product of interest;
determining product recommendations from the selected network members for the product of interest;
analyzing information related to the selected network members to generate weights to be assigned to the product recommendations from the selected network members;
generating a first ranking for the product based on the product recommendations from one or more of the selected network members and the weights to be assigned to the product recommendations from the one of more of the selected network members;
determining product recommendations from various organizations for the product of interest;
generating weights to be assigned to the product recommendations from the organizations;
generating a second ranking for the product of interest based on product recommendations from one or more of the organizations and the weights to be assigned to the product recommendations from the one or more of the organizations;
generating combined ranking for the product of interest based on the first ranking and the second ranking; and
providing combined ranking to the user.

22. The one or more computer-readable storage media of claim 21, wherein the computer process analyzing information related to the selected network members to generate weights further comprising:
determining a social relation score between the user and the selected network members;
determining experience of the selected network members with the product of interest;
determining relation of the selected network members with the geographic location of interest; and
generating weights to be assigned to the product recommendations from the selected network members based on the social relation score between the user and the selected network members, the social relation score between the user and the selected network members, and the relation of the selected network members with the geographic location of interest.
